(19) United States
(12) Patent Application Publication
(10) Pub. No.: US 2009/0056149 A1
(43) Pub. Date: Mar. 5, 2009

(54) Cutting tool for ceiling tiles

(76) Inventor: Andreas Kentrotas, Manhasset, NY (US)

Correspondence Address: COLLARD & ROE, P.C., 1077 NORTHERN BOULEVARD, ROSLYN, NY, 11576, US

(21) Appl. No.: 11/897,214

(22) Filed: Aug. 29, 2007

(51) Int. Cl. B26B 29/00

(52) U.S. Cl. 30/294

(57) ABSTRACT

A cutting device comprises a holder body having a handle and a rabbet edge guide. The rabbet edge guide is disposed along one edge of the handle body and comprises a rabbet with an extending rear face. Adjacent the rabbet on the front face of the holder body is a blade holder mechanism comprising a V-shaped indentation in the holder body and a securing mechanism for a blade. In use, a blade is secured to the blade holder mechanism so that a cutting edge of the blade extends beyond the holder body and into the rabbet, parallel to the extending rear face. A rabbet cut is made in a ceiling tile by pressing the rear face of the holder body against the edge of the tile to be cut, and running the blade along the tile, to create a straight cut that penetrates only a portion of the depth of the tile. The tile is then rotated 90 degrees, and another cut is made into the edge of the tile, with the rear face of the holder body resting against one of the faces of the tile. The two cuts intersect so that a section of the tile is cut away, creating the required recessed edge.

### BACKGROUND OF THE INVENTION

1. Field of the Invention

The invention relates to a cutting tool for creating a recessed edge on a ceiling tile. In particular, the invention relates to a tool having an angled blade of a predetermined dimension, that can be used to accurately finish the edge of a ceiling tile to be placed in a grid in a dropped ceiling.

2. The Prior Art

Ceiling tiles traditionally are sold in pre-set shapes and sizes. They are mounted in a grid that is hung suspended from the ceiling. In some of these arrangements, the ceiling tiles are flat and are shaped to be slightly larger than the openings in the grid. The tiles simply rest on top of the grid and are visible through the openings. In other situations the tiles have recessed edges that rest against the top surface of the grid. The center portion of the tile can then extend below the level of the grid and create a finished appearance. To mount the tiles along the edges of the room, the tile must often be cut into an irregular shape. This results in the elimination of one or more of the recessed edges and prevents smooth mounting of the tile into the grid. In order to create a recessed edge along the cut tile, a perfectly straight rabbet cut must be made in two directions, each being of a precise measurement.

U.S. Pat. No. 6,612,036 to Frazier describes an edge profile cutter having perpendicularly oriented blades, to cut the recessed edge with one pass. While this is ideal in theory, it is very difficult to accomplish in practice, and the cuts will often be irregular and rough, thus ruining the finished look of the ceiling tile.

U.S. Pat. No. 5,048,188 to Wolff discloses a rabbet cutting tool having a blade and two cutting slots for cutting perpendicular slits into a panel, to create a rabbet.

U.S. Pat. No. 4,777,724 also discloses a rabbet cutter. This device is made of many pieces and can be complicated and expensive to manufacture.

### SUMMARY OF THE INVENTION

It is therefore an object of the invention to provide a device for making precise rabbet cuts in a ceiling tile, so that the tile can be mounted in a grid structure and retain a finished appearance.

This object is accomplished by a cutting device comprising a holder body having a handle and a rabbet edge guide. The rabbet edge guide is disposed along one edge of the handle body and comprises a rabbet with an extending rear face. Adjacent the rabbet on the front face of the holder body is a blade holder mechanism comprising a V-shaped indentation in the holder body and a securing mechanism for a blade. In use, a blade is secured to the blade holder mechanism so that a cutting edge of the blade extends beyond the holder body and into the rabbet, parallel to the extending rear face. A rabbet cut is made in a ceiling tile by pressing the rear face of the holder body against the edge of the tile to be cut, and running the blade along the tile, to create a straight cut that penetrates only a portion of the depth of the tile. The tile is then rotated 90 degrees, and another cut is made into the edge of the tile, with the rear face of the holder body resting against one of the faces of the tile. The two cuts intersect so that a section of the tile is cut away, creating the required recessed edge.

In a one embodiment, the blade holder comprises a v-shaped indentation in the holder body. There is a screw penetrating the holder body, so that a blade placed in the V-shaped indent can be screwed securely to the holder body with the screw. Other types of securing arrangements could also be used.

For standard ceiling tiles, the predetermined cutting depth is set ⅜ of an inch. However, the depth can be adjusted simply by adjusting the size of the blade.

In another embodiment, there is a cavity in the holder body for holding additional blades. The cavity can be covered by a sliding cover or a snap-on cap, or any other suitable cover.

The holder body is configured so that it can accommodate a variety of different blades. One type of suitable blade has a straight cutting edge and an overall trapezoidal shape, such as a standard utility knife blade. This blade is mountable in the holder body so that the blade extends at an obtuse angle to an adjacent edge of said holder body. Alternatively, a small, angled blade, such as a hobby knife blade, could also be used. The cutting tool of the present invention is structured so that it uses commercially available blades, which can then be replaced easily and inexpensively.

The blade is preferably mountable in either of two oppositely directed orientations, so that the cutting tool can be used with either a left hand or a right hand, depending on the orientation of the blade. There is a slight overhang in the holder body over the V-shaped indentation, to further secure the blade to the holder body.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of the tool according to the invention;

FIG. 1B shows an enlarged view of section 1B of FIG. 1;

FIG. 2 shows a front view of the tool according to the invention;

FIG. 3 shows a front view of the tool with a blade mounted therein;

FIG. 4 shows a front view of the tool with an alternate blade mounted therein;

FIG. 5 shows the tool making a first cut on a ceiling tile;

FIG. 6 shows the tool making the second cut on a ceiling tile; and

FIG. 7 shows the fully cut ceiling tile of FIGS. 5 and 6.

### DETAILED DESCRIPTION OF THE PREFERRED EMBODIMENT

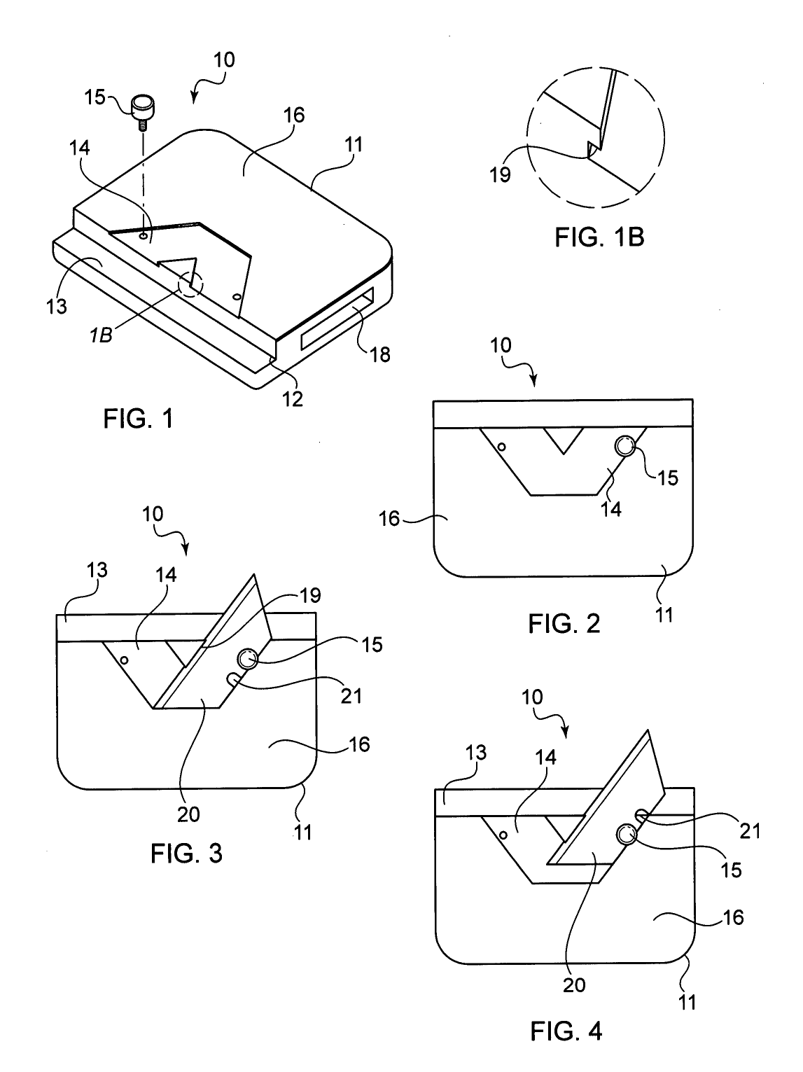

As shown in FIGS. 1-4, the cutting tool according to the invention comprises a holder a holder body 10 having a handle end 11, and a cutting guide comprising a rabbet 12 disposed opposite handle end 11. Extending from rabbet 12 is an extending rear face 13. There is a blade holding device in the form of a V-shaped notch 14 disposed on front face 16 of holder body 10.

A blade 20, as shown in FIG. 3 is mounted to holder body 10, by placing a notch 21 of blade 20 adjacent screw 15 and tightening screw 15. Blade 20 then rests securely in V-shaped notch 14. Notch 14 is configured to mount a blade to the holder body such that the blade projects a predetermined distance beyond the front face 16 and extends parallel with extending rear face 13. An alternative blade, such as a small hobby blade, could also be used with the holder body 10 according to the invention. Notch 14 has an overhanging lip 19, which extends over blade 20 and prevents blade 20 from slipping out of notch 14.

As shown in FIG. 1, there can be a cavity 18 in holder body 10 for holding additional blades. Cavity 18 can be covered with a snap-on or sliding cover (not shown).

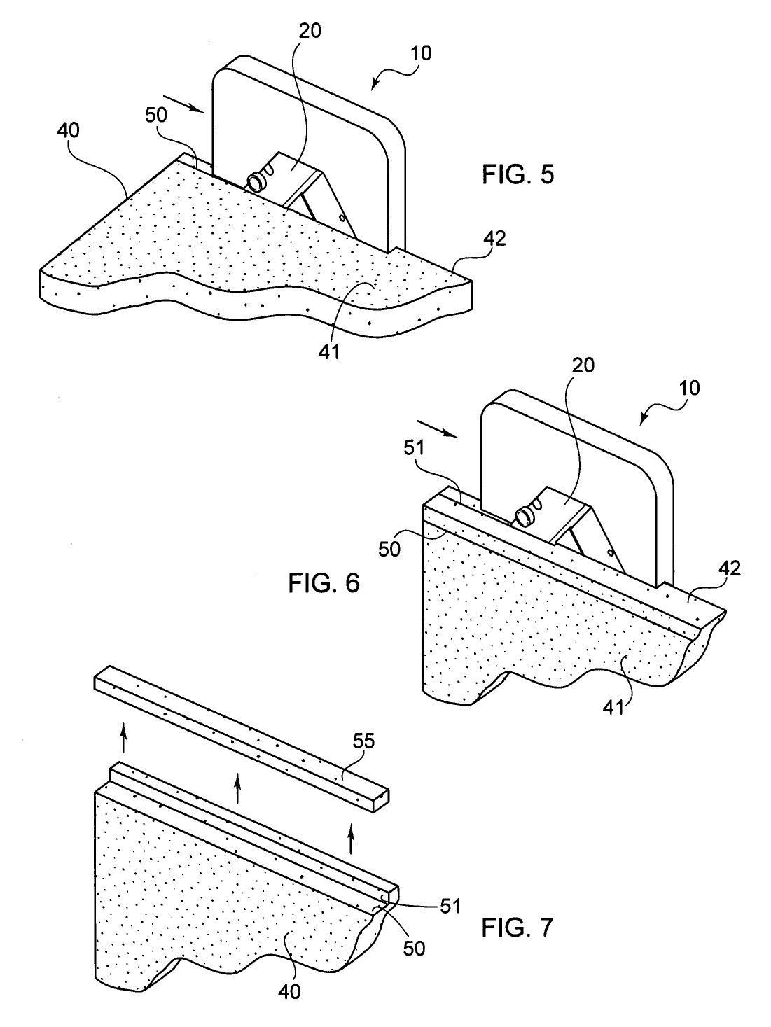

FIGS. 5-7 show the cutting process using the cutting tool according to the invention on a ceiling tile. In a first step, rear face 13 is placed against an edge 42 of the ceiling tile 40, and a straight cut 50 is made with blade 30 along the front face of tile 40. Next, rear face 13 is placed against the rear face of tile 40, until rabbet 12 abuts the edge 42 of tile 40, and a second straight cut 51 is made into the edge 42 of tile 40, as shown in FIG. 6. Cuts 50 and 51 intersect, and a section 55 of tile 40 is thus removed, leaving a precise recessed edge on tile 40, as shown in FIG. 7.

In one embodiment, each cut is made to a depth of ⅜ of an inch, but other size cuts could also be made, depending on the size of the ceiling tile and size of the blade.

Accordingly, while only a few embodiments of the present invention have been shown and described, it is obvious that many changes and modifications may be made thereunto without departing from the spirit and scope of the invention.

What is claimed is:

1. A cutting tool, comprising:
a holder body having a handle end, a cutting guide disposed on an edge opposite the handle end, a front face, a rear face, and a blade holding device disposed on said front face, said cutting guide comprising a rabbet with an extending rear face that extends parallel to the front face of the holder body but is offset from said front face by a predetermined distance,
wherein said blade holding device is configured to mount a blade to the holder body such that the blade projects a predetermined distance beyond the front face and extends parallel with the extending rear face of the cutting guide, such that when said extending rear face is placed against an edge or a face of an object to be cut, the blade penetrates into said object said predetermined distance and makes a cut along said object as the holder body is moved.

2. The cutting tool according to claim 1, wherein said blade holder comprises a v-shaped indentation in said holder body and a screw penetrating said holder body, such that a blade placed in said V-shaped indent can be screwed securely to said holder body with said screw.

3. The cutting tool according to claim 1, wherein said predetermined distance is ⅜ of an inch.

4. The cutting tool according to claim 1, further comprising a cavity in said holder body for holding additional blades.

5. The cutting tool according to claim 2, further comprising a blade having a straight cutting edge and an overall trapezoidal shape, said blade being mountable in said holder body so that said blade extends at an obtuse angle to an adjacent edge of said holder body.

6. The cutting tool according to claim 5, wherein said blade is mountable in either of two oppositely directed orientations, so that the cutting tool can be used with either a left hand or a right hand, depending on the orientation of the blade.

7. The cutting tool according to claim 2, wherein the holder body has an overhanging lip that projects over the V-shaped notch to prevent a blade mounted in the notch from slipping out of the notch.

8. A method for creating a recessed edge on a ceiling tile, with a cutting tool comprising:
a holder body having a handle end, a cutting guide disposed on an edge opposite the handle end, a front face, a rear face, and a blade holding device disposed on said front face, said cutting guide comprising a rabbet with an extending rear face that extends parallel to the front face of the holder body but is offset from said front face by a predetermined distance,
wherein said blade holding device is configured to mount a blade to the holder body such that the blade projects a predetermined distance beyond the front face and extends parallel with the extending rear face of the cutting guide, the method comprising the following steps:
placing the extending rear face against an edge of the ceiling tile so that said blade is aimed at a front face of said ceiling tile;
pressing the blade toward the front face of ceiling tile until the blade penetrates the ceiling tile;
moving the holder body along the ceiling tile until a first cut is made into the ceiling tile, said cut running parallel to the edge of said ceiling tile and penetrating only a partial depth of said ceiling tile;
removing the cutting tool from the ceiling tile;
placing the cutting tool against the ceiling tile so that the extending rear face rests against a rear face of said ceiling tile and said blade penetrates said edge of said ceiling tile;
moving the holder body along said tile so that said blade makes a second cut, said second cut running along the edge of said ceiling tile perpendicular to said first cut, wherein said first cut and said second cut intersect; and
removing a portion of said ceiling tile that has been cut away by said intersecting cuts.
